(19) United States
(12) Patent Application Publication
(10) Pub. No.: US 2025/0083731 A1
(43) Pub. Date: Mar. 13, 2025

(54) STEERING SYSTEM FOR VEHICLES

(71) Applicant: Gussi Italia S.r.l., Tregnago (IT)

(72) Inventor: Paolo RANCAN, Badia Calavena (IT)

(21) Appl. No.: 18/882,255

(22) Filed: Sep. 11, 2024

(30) Foreign Application Priority Data
Sep. 12, 2023 (IT) 102023000018636

(51) Int. Cl. B62D 1/04

(52) U.S. Cl. CPC B62D 1/046

(57) ABSTRACT

A steering system for vehicles that includes a steering device associated with a vehicle and provided with a steering wheel provided with a body configured to be gripped by the user and rotationally actuatable by the user, about an axis of rotation, in order to impart changes of direction to the vehicle. The steering device includes at least one button which can be operated by the user to control or set at least one onboard system installed on the vehicle; a display configured to display the commands or settings imparted by means of the button is mounted on the body of the steering wheel.

### CROSS-REFERENCE TO RELATED APPLICATIONS

This application claims priority under 35 U.S.C. § 119 (b) to Italian Application No. 102023000018636, filed Sep. 12, 2023, the disclosure of which is incorporated herein by reference in its entirety.

### BACKGROUND OF THE INVENTION

The present invention relates to a steering system for vehicles.

In particular, the present invention relates to a steering system particularly but not exclusively suitable for application on boats or the like.

It is known that vehicles, such as cars, boats, and the like, are provided with a steering system that allows the user to change the direction of vehicle motion while the vehicle is moving.

Typically, steering systems comprise a steering device provided with a steering wheel, which has a body that can be gripped by the user, which can be actuated manually in rotation, about an axis, by the user himself to impart changes of direction to the vehicle.

Current steering devices are usually provided, substantially at the steering wheel, with one or more buttons that can be operated manually by the user to give commands or settings to a variety of onboard systems installed in the vehicle, for example, driver assistance systems, infotainment systems, or others.

It is also known that an instrument panel is provided on the dashboard of cars, typically behind the steering wheel, and may be provided with a display configured to display information related to the operation of the car or of the systems installed in it.

In boats, on the other hand, the possibility of applying a display behind the steering wheel is not available.

### BRIEF SUMMARY OF THE INVENTION

The aim of the present invention is to provide a vehicle steering system that is capable of improving the background art in one or more of the above-mentioned aspects. Within this aim, an object of the invention is to provide a steering system that can display commands or settings given by the user to systems installed on the vehicle.

Another object of the invention is to provide a steering system that is structurally simple and convenient to use.

Another object of the invention is to provide a steering system that can be easily configured by the user according to his needs.

Another object of the invention is to provide a steering system that is reliable and safe in its operation.

A further object of the present invention is to overcome the drawbacks of the background art in a manner that is alternative to any existing solutions.

Not least object of the invention is to provide a steering system that is competitive even from a purely economic point of view.

This aim, as well as these and other objects which will become better apparent hereinafter, are achieved by a vehicle steering system according to claim 1, optionally provided with one or more of the characteristics of the dependent claims.

### BRIEF DESCRIPTION OF THE SEVERAL VIEWS OF THE DRAWING

The foregoing summary, as well as the following detailed description of the preferred invention, will be better understood when read in conjunction with the appended drawings. For the purpose of illustrating the preferred invention, there are shown in the drawings embodiments which are presently preferred. It should be understood, however, that the invention is not limited to the precise arrangements and instrumentalities shown. In the drawings:

FIG. 1 is a perspective view of the system according to the invention;

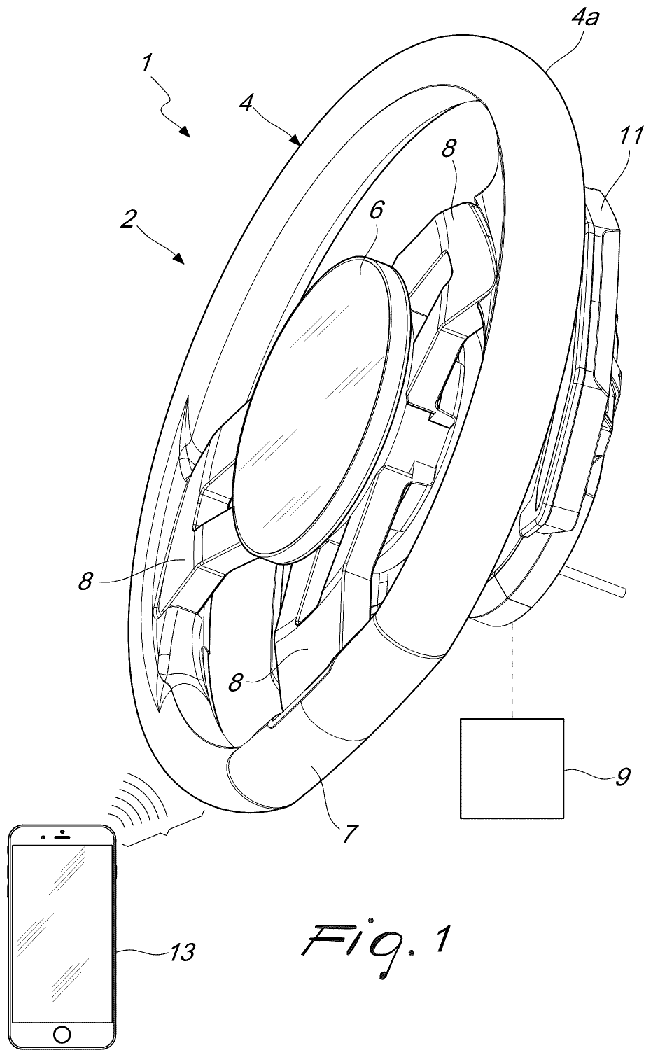

FIG. 2 is a side view of the system according to the invention;

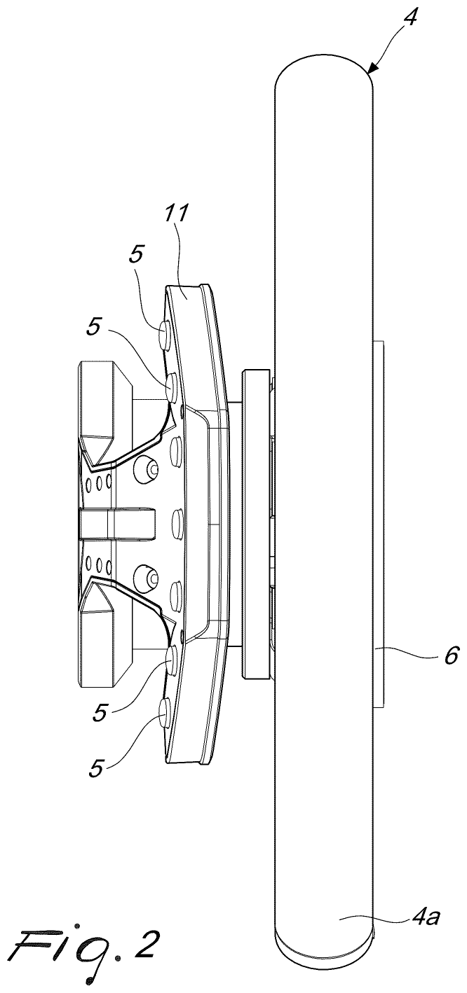

FIG. 3 is a perspective view of the system according to the invention applied to a vehicle;

FIG. 4 is a front view of the system according to the invention;

FIG. 5 is a front view of the system according to the invention with the steering wheel in an angularly displaced position, about its axis of rotation, with respect to FIG. 4.

### DETAILED DESCRIPTION OF THE INVENTION

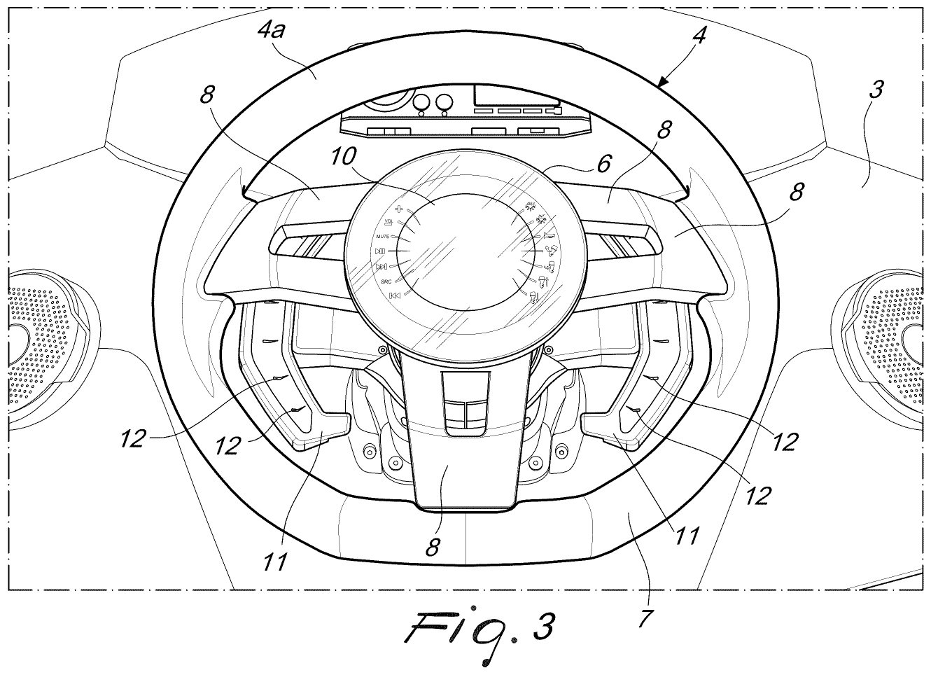

With reference to the figures, the steering system for vehicles according to the invention, generally designated by the reference numeral 1, comprises a steering device 2 which is associated with a vehicle 3, partially shown in FIG. 3 and constituted by, for example, a boat or the like.

In particular, the steering device 2 is provided with a steering wheel 4 provided with a body 4a that can be gripped by the user and can be actuated rotatably by the user, about an axis of rotation, to impart changes of direction to the vehicle 3.

The steering device 4 comprises, moreover, at least one button 5 which can be operated by the user to control or set at least one onboard system installed on the vehicle 3, such as, for example, a driver assistance system, an infotainment system or other systems.

Conveniently, multiple buttons 5 selectively actuatable by the user may be provided on the steering device 4 to impart different commands or settings to multiple onboard systems installed on the vehicle 3.

According to the invention, a display 6 configured to display the commands or settings imparted by means of the buttons 5 to the onboard systems of the vehicle 3 is mounted on the body 4a of the steering wheel 4.

Conveniently, the display 6 is integrally fixed to the steering wheel body 4a and is advantageously positioned centrally with respect to the body 4a of the steering wheel 4.

In particular, the body 4a of the steering wheel has in practice, as per se known, a grip ring 7 and a plurality of spokes 8, which extend radially from the axis of rotation of the steering wheel 4 toward the grip ring 7.

More particularly, the display 6 is conveniently positioned substantially at the axis of rotation of the steering wheel 4.

Conveniently, the display 6 displays at least one screen 10 showing indications depicted, for example, by means of pictures and/or icons, which indicate the commands and/or settings imparted to the onboard systems of the vehicle 3 by means of the user's actuation of the buttons 5.

A graphic sign, such as a logo or the like, indicating the manufacturer of the vehicle 3, may also possibly be displayed on the screen 10 of the display 6.

Preferably, the display 6 is of the touch screen type.

In this way, by touching the display 6 the user will conveniently be able to alternately display mutually different screens 10 on the display 6, such as, for example, a screen showing the commands or settings that can be imparted by means of the buttons 5 and, in the center, the logo of the manufacturer of the vehicle 3, a screen with the indication of the commands or settings that can be imparted by means of the buttons 5 and, in the center, other information chosen by the user and related to the vehicle 3 and its operation (for example, speedometer, fuel level, and so on), or a screen with only the enlarged logo of the manufacturer of the vehicle 3 in the center.

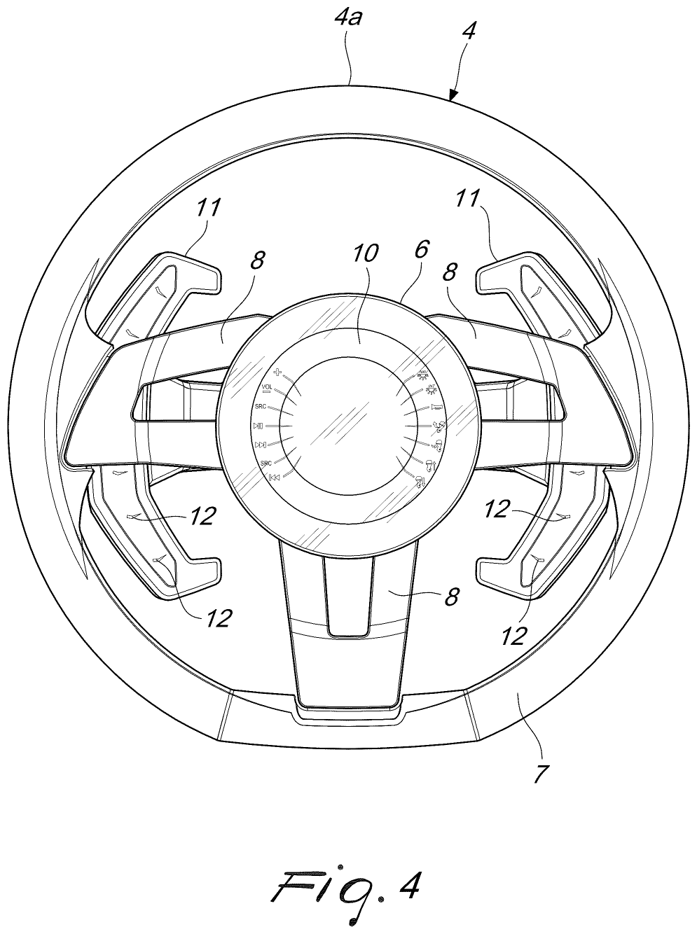

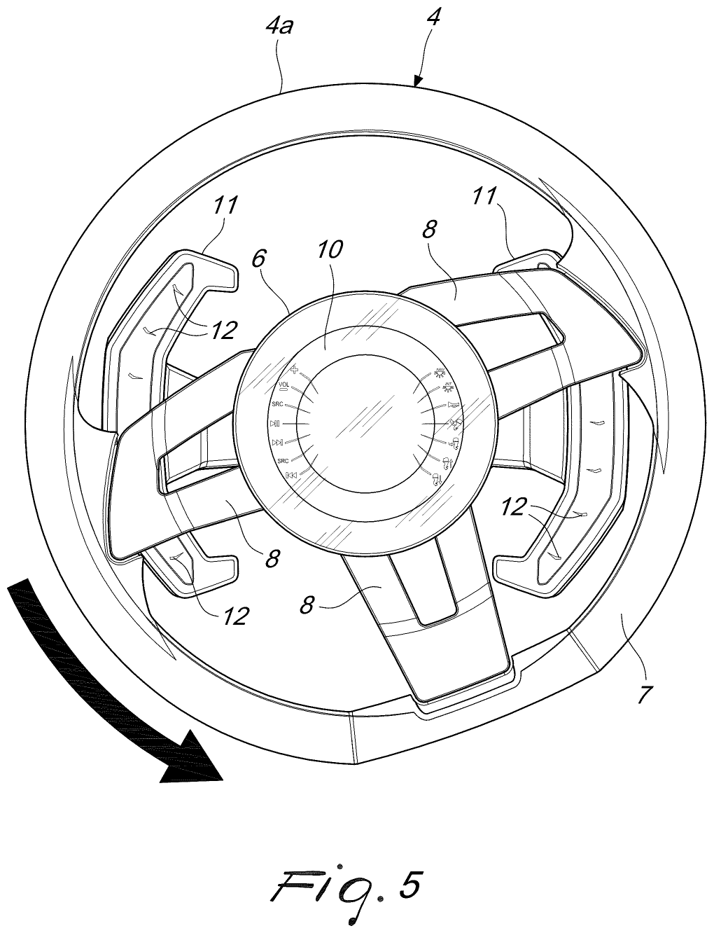

Advantageously, the steering system according to the invention comprises an electronic gyroscope 9 which is functionally connected to the display 6 and is configured to allow to keep the screen 10 displayed by the display 6 in a predetermined fixed reading position, regardless of the angular position assumed by the steering wheel 4 about its axis of rotation, as shown in FIGS. 4 and 5.

This allows the user to perceive without difficulty, in any position of the steering wheel 4, the indications shown by the screen of the display, to the full advantage of safety.

Advantageously, the button or buttons 5 are mounted on at least one respective supporting wing 11 which is arranged behind the steering wheel 4 relative to the position in which the user is located.

Preferably, as in the example shown, there are two supporting wings 11, which are arranged mutually opposite with respect to the axis of rotation of the steering wheel 4 and each support respective buttons 5.

For example, the buttons 5 are mounted on the side of the supporting wings 5 that faces away from the user, while indicator lights adapted to indicate the activation status of the buttons 5 may be provided, in a position corresponding to each button 5, on the side of the supporting wings 11 directed toward the user.

Conveniently, the buttons 5 and the display 6 are connected to each other by virtue of short-range wireless communication means, such as, for example, a Bluetooth type device, while the steering device 2 is advantageously interconnected with the onboard systems of the vehicle 3 by means of a CANBUS network.

Preferably, the system according to the invention further comprises a mobile processing device 13 which can be operated by the user and is connectable to the steering device 4 by means of a short-range wireless communication network, for example of the Bluetooth type.

For this purpose, both the mobile processing device 13 and the steering device 2 are provided with respective short-range wireless communication modules in order to enable the exchange of data and information between the mobile processing device 13 and the steering device 2.

In particular, the mobile processing device 13 is conveniently constituted by a tablet or a smartphone and is configured, by means of an appropriate application installed therein, to allow the user to vary the screen 10 displayed by the display 6 and/or the type of command or setting that can be imparted by the user by means of the buttons 5.

By means of the mobile processing device 13 it will also be optionally possible to change the color of the indicator lights 12 or to vary other configurations of the steering 2 device as well.

Conveniently, the steering device 2 is provided so as to be waterproof, so that it can also be installed in an open environment, such as in the case of boats.

The operation of the system, according to the invention, is as follows.

While the vehicle is in motion, the display 6 shows on the screen 10 the commands and settings that the user has imparted to the onboard systems of the vehicle 3 by operating the corresponding buttons 5.

When the user rotates the body 4a of the steering wheel 4 to impart a change of direction to the vehicle, the screen 10, thanks to the electronic gyroscope 9, remains in a fixed position so that the user can immediately read the indications shown by display 6.

In practice it has been found that the invention achieves its intended aim and objects, providing a steering system that allows the user to easily and effortlessly view the commands and settings he has imparted to the vehicle's various onboard systems.

The invention thus conceived is susceptible of numerous modifications and variations, all of which are within the scope of the appended claims.

Thus, for example, although the system according to the invention has been described in relation to its application on boats, it may also be used on other types of vehicles, such as cars.

All the details may furthermore be replaced with other technically equivalent elements.

In practice, the materials used, as well as the contingent shapes and dimensions, may be any according to the requirements and the state of the art.

The disclosures in Italian Patent Application No. 102023000018636 from which this application claims priority are incorporated herein by reference.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A steering system for vehicles, comprising a steering device associated with a vehicle and provided with a steering wheel provided with a body configured to be gripped by the user and rotationally actuatable by the user, about an axis of rotation, in order to impart changes of direction to said vehicle, said steering device comprising at least one button which can be operated by the user to control or set at least one onboard system installed on said vehicle, wherein a display configured to display the commands or settings imparted by means of said at least one button is mounted on the body of said steering wheel.

2. The system according to claim 1, further comprising an electronic gyroscope which is functionally connected to said display and is configured to maintain an image displayed by said display in a predetermined fixed reading position, regardless of the angular position assumed by said steering wheel about said axis of rotation.

3. The system according to claim 1, wherein said at least one button is mounted on at least one respective supporting wing arranged at a rear of said steering wheel.

4. The system according to claim 1, wherein said at least one button and said display are mutually connected by virtue of short-range wireless communication means.

5. The system according to claim 1, wherein said steering device is interconnected with said onboard systems by means of a CANBUS network.

6. The system according to claim 1, further comprising a mobile processing device which is configured to be operated by the user and is connectable, by means of a short-range wireless communication network, to said steering device, said mobile processing device being configured to allow the user to vary the image displayed by said display and/or a type of command or setting that can be given by the user by means of said button.
